(19) United States
(12) Patent Application Publication
(10) Pub. No.: US 2026/0158935 A1
(43) Pub. Date: Jun. 11, 2026

(54) DRIVE DEVICE FOR A VEHICLE

(71) Applicant: AUDI AG, Ingolstadt (DE)

(72) Inventor: Manuel PAßLER, Weißenburg (DE)

(73) Assignee: AUDI AG, Ingolstadt (DE)

(21) Appl. No.: 18/706,859

(22) PCT Filed: Aug. 10, 2022
(86) PCT No.: PCT/EP2022/072419

§ 371 Date: May 2, 2024

(30) Foreign Application Priority Data
Dec. 15, 2021 (DE) 10 2021 133 186.2

(51) Int. Cl. B60L 15/20; B60L 3/00; B60L 15/00

(52) U.S. Cl. CPC B60L 15/20; B60L 3/0061; B60L 15/007; B60L 2250/28

(57) ABSTRACT

A drive device for a vehicle, including an accelerator pedal (FP), which is in signal connection with a drive control (ASG), which requests a torque (MASG) on the basis of an accelerator pedal raw value (RFP), with which an actuator control (PWR) of an actuator (EM), in particular a pulse inverter of an electric machine, can be controlled during driving operation. The actuator control (PWR) has an enabling device by which an error determination of the torque (MASG) requested by the drive control (ASG) can be carried out.

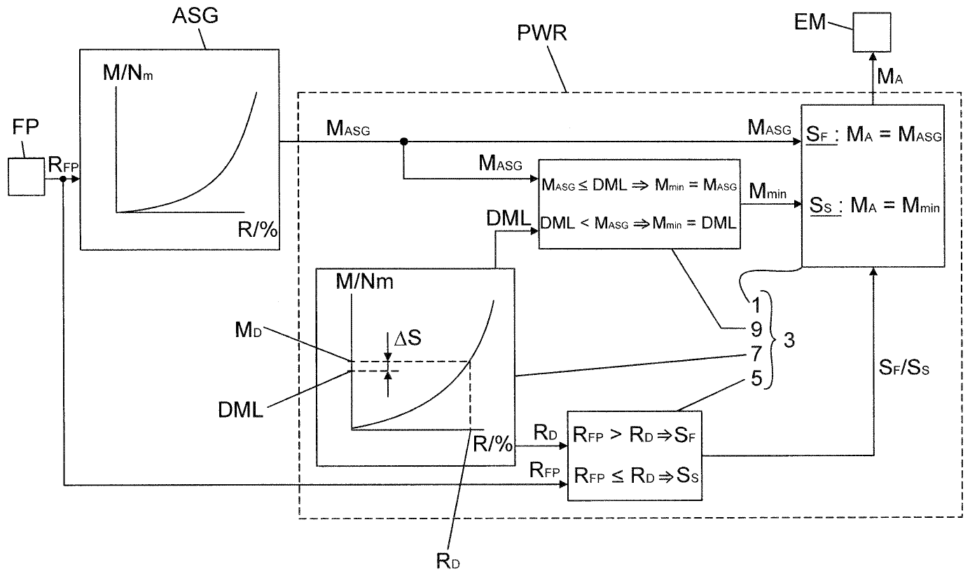

### FIELD

The invention relates to a drive device for a vehicle, in particular an electrically operated vehicle.

### BACKGROUND

Such a drive device has an accelerator pedal that is in signal connection with a drive control. The drive control generates a desired torque based on an accelerator pedal raw value initiated by the driver. A pulse inverter converts this target torque in conjunction with an electric machine. The electric machine is only mentioned here as an example. Alternatively, any other actuator can be used.

When the accelerator pedal is actuated accordingly, the drive torque generated by the drive is greater than a vehicle-specific destabilization threshold, above which a static friction coefficient limit between the vehicle wheels and the road surface is exceeded during driving, resulting in vehicle destabilization. A distinction is made between a high coefficient of static friction limit on dry road surfaces, a medium coefficient of static friction limit on wet road surfaces and a low coefficient of static friction limit on icy road surfaces. Particularly in a vehicle with a high drive performance, the electric machine can convert drive torques that exceed even the destabilization threshold corresponding to the high static friction limit.

With regard to vehicle safety, the functional safety of the accelerator pedal, the drive control and the pulse inverter must meet very high safety requirements so that in the signal processing path between the accelerator pedal and the pulse inverter the incorrect generation of excessive drive torque that exceeds the destabilization threshold is prevented.

### SUMMARY

The object of the invention is to provide a drive device with an operationally reliable signal processing path between the accelerator pedal and the drive unit, which has a simple design compared to prior art and, in particular, in which the path of the drive control allows a higher fault tolerance.

The invention is based on a drive device for a vehicle in which an accelerator pedal is connected in signal connection to a drive control. The drive control requests a torque from the actuator control on the basis of a driver-side accelerator pedal raw value. The torque requested or generated by the drive control is used to control an actuator control (e.g. pulse inverter) of an actuator (e.g. electric machine). According to the disclosure, the actuator control has an enabling device by means of which an error determination of the torque requested by the drive control can be carried out.

In accordance with the invention, a signal processing path is therefore provided between the accelerator pedal and the actuator (e.g. the electric machine), in which the enabling device is installed directly in the actuator control. The drive torque required by the drive control is therefore not checked in the drive control itself, but rather downstream in the actuator control. By means of the enabling device according to the invention, a potentially dangerous, destabilizing torque is only enabled if the customer explicitly requests this. This request is made by the customer by depressing the accelerator pedal.

The routine in the enabling device is performed on the basis of the accelerator pedal raw value, the predefined vehicle-specific destabilization threshold and the torque requested by the drive control. Against this background, the signal processing in the accelerator pedal and the signal processing in the actuator control in particular must be designed with a higher safety integrity compared to the signal processing in the drive control. For example, the functional safety of the accelerator pedal and the functional safety of the actuator control can meet high safety requirements according to ISO 26262 (e.g. ASIL D), while the drive control can meet lower safety requirements (e.g. ASIL C). In this case, the actuator control can have a simpler and therefore more cost-effective design compared to an actuator control designed for higher safety requirements (e.g. ASIL D). Alternatively, the accelerator pedal and the actuator control can be designed in accordance with ISO 26262 in accordance with ASIL C, while the drive control can be designed with lower safety requirements in accordance with ASIL B. However, this depends on the destabilization potential of the installed drive units.

When an error-free torque is determined, the enabling device can enable the torque requested by the drive control in the direction of the drive unit without limitation. In this case, the actuator control controls the drive unit on the basis of the torque requested by the drive control. In contrast, if a faulty torque is determined, the enabling device can inhibit the torque in the direction of the drive unit. Instead, the enabling device can enable a minimum torque in the direction of the drive unit and thus limit the torque of the drive control.

The minimum torque mentioned above is preferably less than a vehicle-specific destabilization threshold. Once such a destabilization threshold is reached, a static friction coefficient limit (on dry, wet or icy road surfaces) between the vehicle wheels and the road surface is exceeded during driving, resulting in vehicle destabilization.

In a technical implementation, the routine can be designed so that the error is determined at least when the torque requested by the drive control is greater than the vehicle-specific destabilization threshold. In contrast, the enabling device can remain deactivated if the torque requested by the drive control is less than the vehicle-specific destabilization threshold.

It is preferable if the enabling device can be realized with little software effort and can operate with little computational effort. Against this background, the enabling device can be structured as follows: The enabling device can have a comparator module in which the accelerator pedal raw value generated by the accelerator pedal can be compared with a limit value. The limit value can preferably be formed from an accelerator pedal raw value that correlates with the vehicle-specific destabilization threshold.

If the accelerator pedal raw value generated by the accelerator pedal is greater than the limit value, the comparator module can generate an enable signal. With the help of the enable signal, a switched release module in the signal processing path can enable the requested torque of the drive control in the direction of the drive unit. Conversely, if the accelerator pedal raw value generated by the accelerator pedal is less than the limit value, the comparator module can generate an inhibit signal. With the aid of the inhibit signal, the release module connected in the signal processing path can inhibit the torque requested by the drive control in the direction of the drive unit. Instead, the release module can enable the minimum torque in the direction of the drive unit.

The enabling device also has a minimum selection module. This is in signal connection with the release module. In the minimum selection module, a selection is made between a predefined torque limit, which is smaller than the destabilization threshold, and the torque requested by the drive control. The minimum selection module selects the smaller value from these two parameters, which is defined as the minimum torque.

This ensures that the enabling device only releases the torque requested by the drive control in the direction of the drive unit if it is ensured that the torque is less than the destabilization threshold, or if it is ensured that, on the one hand, the torque is greater than the destabilization threshold and, on the other hand, the accelerator pedal raw value generated by the accelerator pedal is greater than the limit value defined above.

### BRIEF DESCRIPTION OF THE FIGURES

In the following, an embodiment of the invention is described with reference to the attached FIGURE, in which a drive device for an electrically operated vehicle is shown in a schematic block circuit diagram.

### DETAILED DESCRIPTION

In the FIGURE, the drive device has an accelerator pedal FP, which is in signal connection with a drive control ASG. The drive control ASG requests a torque M_{ASG} based on an accelerator pedal raw value R_{FP} initiated by the driver. The torque M_{ASG} is used to control a pulse inverter PWR of an electric machine EM during driving operation. In the drive control ASG, the torque M_{ASG} is generated, among other things, on the basis of a characteristic curve in which the torque M_{ASG} is plotted as a function of the accelerator pedal travel, i.e. the accelerator pedal raw value R_{FP}. In addition, there are various other influencing factors that determine the torque, such as Drive Select preselection.

In the further signal processing path, the torque M_{ASG} requested by the drive control ASG is applied to the signal input of a release module 1. The release module 1 is part of an enabling device 3 installed in the PWR pulse inverter, which is used to determine an error in the torque M_{ASG} requested by the drive control ASG. If the enabling device 3 determines an error-free torque M_{ASG}, the release module 1 releases the torque M_{ASG} as a drive torque M_{A} in the direction of the electric machine EM. In this case, the pulse inverter PWR controls the electric machine EM on the basis of the torque M_{ASG} requested by the drive control ASG.

If the enabling device 3 determines a faulty torque M_{ASG}, the release module 1 inhibits the torque M_{ASG} in the direction of the electric machine EM. Instead, release module 1 releases a minimum torque Mₘᵢₙ in the direction of electric machine EM.

As can also be seen from the FIGURE, the enabling device 3 has a comparator module 5, which is in signal connection with the release module 1. In the comparator module 5, the accelerator pedal raw value R_{FP} generated by the accelerator pedal FP is compared with a limit value R_{D}. The limit value R_{P} is read into the comparator module 5 from an applicable characteristic curve stored in a database 7. The characteristic curve shows the torque M_{ASG} requested by the drive control ASG as a function of the accelerator pedal raw value (i.e. accelerator pedal travel). A vehicle-specific destabilization threshold M_{D} is entered in the characteristic curve, above which a static friction coefficient limit between the vehicle wheels and the road is exceeded during driving, resulting in vehicle destabilization. The characteristic curve also shows the accelerator pedal raw value R_{D}, which correlates with the vehicle-specific destabilization threshold M_{D} and forms the limit value for comparator module 5.

If the accelerator pedal raw value R_{FP} generated by the accelerator pedal FP is greater than the limit value R_{D}, an enable signal S_{F} is generated in the comparator module 5. If the enable signal SF is present at the signal input of the release module 1, the release module 1 releases the torque M_{ASG} requested by the drive control ASG in the direction of the electric machine EM.

However, if the accelerator pedal raw value R_{FP} generated by the accelerator pedal FP in comparator module 5 is less than the limit value R_{D}, comparator module 5 generates an inhibit signal S_{S}. If the inhibit signal Ss is present at the signal input of release module 1, this inhibits the torque M_{ASG} generated by the drive control ASG and instead releases the minimum torque Mₘᵢₙ in the direction of the electric machine EM. The release module 1 therefore limits the torque M_{ASG} requested by the drive control ASG to the minimum torque Mₘᵢₙ and releases this in the direction of the EM electric machine. An error in the drive control ASG would therefore not affect the torque generated by the electric machine EM, but would be limited to a less critical, controllable value.

The enabling device 3 also has a minimum selection module 9, which is also in signal connection with the release module 1. In the FIGURE, a torque limit DML is read into the minimum selection module 9 from the characteristic curve stored in the database 7. The torque limit DML is smaller than the destabilization threshold M_{D} by a safety margin AM.

The minimum selection module 9 selects the lower value from the torque limit DML and the torque M_{ASG} requested by the drive control ASG and defines this as the minimum torque Mₘᵢₙ. The minimum torque Mₘᵢₙ is present together with the torque M_{ASG} at the signal input of release module 1.

The operation of the enabling device 3 is explained below using a first example, in which the accelerator pedal FP is actuated to 80%, so that the accelerator pedal raw value R_{FP} is 80%. In error-free normal operation, the drive control ASG determines (using the stored characteristic curve) a requested torque M_{ASG} of 3500 Nm from the accelerator pedal raw value R_{FP} of 80%. The destabilization threshold M_{D}, for example, is 4000 Nm, while the torque limit DML is 100 Nm lower, at 3900 Nm. The accelerator pedal raw value RD, which correlates with the destabilization threshold MD, is 90%. As the accelerator pedal raw value R_{FP} generated by the accelerator pedal FP is lower than the limit value RD, an inhibit signal Ss is generated in the comparator module 5 and applied to the release module 1.

In addition, the torque M_{ASG} and the torque limit DML are present at the signal input of the minimum selection module 9. As the torque M_{ASG} (3500 Nm) is lower than the torque limit (3900 Nm), the torque M_{ASG} is defined as the minimum torque Mₘᵢₙ in the minimum selection module 9. Accordingly, release module 1 releases the minimum torque Mₘᵢₙ as the drive torque M_{A} in the direction of the electric machine EM.

In a second example, faulty signal processing occurs in the drive control ASG with otherwise identical output parameters as in the first example. Accordingly, an incorrect, excessively high torque of 6000 Nm is generated in the drive control ASG instead of an error-free torque M_{ASG} of 3500 Nm. In this case, the incorrectly requested torque M_{ASG} is above the destabilization threshold MD (4000 Nm). If such an excessively high torque M_{ASG} is applied to the electric machine EM, vehicle destabilization would therefore occur. Vehicle destabilization would only occur if the driver is travelling with a certain lateral acceleration (cornering). Statistically speaking, this situation is very likely.

In the second example above, the incorrectly requested torque M_{ASG} (6000 Nm) is significantly greater than the torque limit (3900 Nm). Accordingly, the minimum selection module 9 sets the torque limit of 3900 Nm as the minimum torque Mₘᵢₙ. In the further course of the signal, the release module 1, to which the inhibit signal S_{S} is applied, therefore releases the minimum torque Mₘᵢₙ (corresponding to torque limit DML) as the drive torque M_{A} in the direction of the electric machine EM. This reliably prevents the electric machine EM from being driven with the excessively high, incorrect torque M_{ASG} of 6000 Nm.

A third example concerns the same constellation as above, but with an accelerator pedal raw value R_{FP} generated by the accelerator pedal FP of, for example, 95% instead of 80%. This results in the following situation: Since the accelerator pedal raw value R_{FP} generated by the accelerator pedal FP is now greater than the limit value R_{D}, an enable signal S_{F} is generated in the comparator module 5, which is applied to the signal input of the release module 1. In this case, the accelerator pedal FP is actuated by the driver to such an extent that a potentially destabilizing torque has been authorized by the driver during certain driving manoeuvres. The release module 1 therefore releases the torque M_{ASG} as drive torque M_{A} in the direction of the electric machine EM.

### LIST OF REFERENCE NUMERALS

1 release module
3 enabling device
5 comparator module
7 database
9 minimum selection module
FP accelerator pedal
ASG drive control
PWR actuator control
R_{FP} the accelerator pedal raw value generated by the accelerator pedal
M_{ASG} the torque requested by the drive control
DML torque limit
M_{D} destabilization threshold
Mₘᵢₙ minimum torque
M_{A} drive torque
R_{D} limit value
S_{F} enable signal
S_{S} inhibit signal
EM electric machine

1-7. (canceled)

8. A drive device for a vehicle, comprising an accelerator pedal (FP) which is in signal connection with a drive control (ASG) which requests a torque (M_{ASG}) on the basis of an accelerator pedal raw value (R_{FP}), with which torque an actuator control (PWR) of an actuator (EM), in particular a pulse inverter of an electric machine, can be controlled during driving operation, wherein the actuator control (PWR) has an enabling device by which an error determination of the torque (M_{ASG}) requested by the drive control (ASG) can be carried out.

9. The drive device according to claim 8, wherein, when an error-free torque (M_{ASG}) is determined, the enabling device releases the torque (M_{ASG}) in the direction of the drive unit (EM), so that the actuator control (PWR) actuates the drive unit (EM) on the basis of the torque (M_{ASG}) requested by the drive control (ASG), and/or wherein, when a faulty torque (M_{ASG}) is determined, the enabling device inhibits the torque (M_{ASG}) in the direction of the drive unit (EM) and instead releases a minimum torque (Mₘᵢₙ) in the direction of the drive unit (EM).

10. The drive device according to claim 9, wherein the minimum torque (Mₘᵢₙ) is smaller than a vehicle-specific destabilization threshold (M_{D}), above which a static friction coefficient limit between the vehicle wheels and the road surface is exceeded in driving operation, so that vehicle destabilization occurs.

11. The drive device according to claim 8, wherein the error determination takes place at least when the torque (M_{ASG}) requested by the drive control (ASG) is greater than the vehicle-specific destabilization threshold (M_{D}).

12. The drive device according to claim 8, wherein the enabling device has a comparator module in which the accelerator pedal raw value (R_{FP}) generated by the accelerator pedal (FP) is comparable with a limit value (R_{D}), and wherein the limit value (R_{D}) is formed from an accelerator pedal raw value correlating with the vehicle-specific destabilization threshold (M_{D}).

13. The drive device according to claim 12, wherein, if the accelerator pedal raw value (R_{FP}) generated by the accelerator pedal (FP) is greater than the limit value (R_{D}), the comparator module generates an enable signal (S_{F}), by which a release module releases the torque (M_{ASG}) in the direction of the drive unit (EM), or wherein, if the accelerator pedal raw value (R_{FP}) generated by the accelerator pedal (FP) is less than the limit value (R_{D}), the comparator module generates an inhibit signal (S_{S}), by which the release module inhibits the torque (M_{ASG}) in the direction of the drive unit (EM) and instead releases the minimum torque (Mₘᵢₙ) in the direction of the drive unit (EM).

14. The drive device according to claim 13, wherein the enabling device has a minimum selection module, which is in signal connection with the release module, and wherein the minimum selection module selects the smaller value from a torque limit (DML), which is smaller than the destabilization threshold (M_{D}), and from the torque (M_{ASG}) requested by the drive control (ASG) and defines it as the minimum torque (Mₘᵢₙ).

15. The drive device according to claim 9, wherein the error determination takes place at least when the torque (M_{ASG}) requested by the drive control (ASG) is greater than the vehicle-specific destabilization threshold (M_{D}).

16. The drive device according to claim 10, wherein the error determination takes place at least when the torque (M_{ASG}) requested by the drive control (ASG) is greater than the vehicle-specific destabilization threshold (M_{D}).

17. The drive device according to claim 9, wherein the enabling device has a comparator module in which the accelerator pedal raw value (R_{FP}) generated by the accelerator pedal (FP) is comparable with a limit value (R_{D}), and wherein the limit value (R_{D}) is formed from an accelerator pedal raw value correlating with the vehicle-specific destabilization threshold (M_{D}).

18. The drive device according to claim 10, wherein the enabling device has a comparator module in which the accelerator pedal raw value (R_{FP}) generated by the accelerator pedal (FP) is comparable with a limit value (R_{D}), and wherein the limit value (R_{D}) is formed from an accelerator pedal raw value correlating with the vehicle-specific destabilization threshold (M_{D}).

19. The drive device according to claim 11, wherein the enabling device has a comparator module in which the accelerator pedal raw value (R_{FP}) generated by the accelerator pedal (FP) is comparable with a limit value (R_{D}), and wherein the limit value (R_{D}) is formed from an accelerator pedal raw value correlating with the vehicle-specific destabilization threshold (M_{D}).
